(19) United States
(12) Patent Application Publication
(10) Pub. No.: US 2023/0269021 A1
(43) Pub. Date: Aug. 24, 2023

(54) A CONTROLLER FOR CONTROLLING WIRELESS COMMUNICATION BETWEEN A NODE AND A MASTER DEVICE IN A WIRELESS NETWORK AND A METHOD THEREOF

(71) Applicant: SIGNIFY HOLDING B.V., EINDHOVEN (NL)

(72) Inventor: MOHAMMAD FAL SADIKIN, EINDHOVEN (NL)

(21) Appl. No.: 18/018,185

(22) PCT Filed: Jul. 21, 2021
(86) PCT No.: PCT/EP2021/070319

§ 371 Date: Jan. 26, 2023

(30) Foreign Application Priority Data
Aug. 4, 2020 (EP) 20189304.7

(51) Int. Cl. H04K 3/00

(52) U.S. Cl. CPC H04K 3/43; H04K 3/825; H04K 3/41; H04K 2203/18

(57) ABSTRACT

A controller for controlling wireless communication between a node and a master device in a wireless network; wherein the controller comprises a processor arranged for: determining a first directionally restricted jamming area relative to the node; determining a second directionally restricted jamming area relative to the master device; controlling a first directional antenna to transmit a first jamming signal in the first determined directionally restricted jamming area during a predetermined time period; and controlling a second directional antenna to transmit a second jamming signal in the second determined directionally restricted jamming area during the predetermined time period.

### FIELD OF THE INVENTION

The invention relates to a controller for controlling wireless communication between a node and a master device in a wireless network. The invention further relates to a system, a method and a computer program product for controlling wireless communication between a node and a master device in a wireless network.

### BACKGROUND

Systems built around smart devices and home networks typically fall under the heading of smart home systems. Smart home systems, such as connected lighting system, are often connected to the Internet, typically such that they may be controlled by a user when (s)he is out-of-home. Although referred to above as a ‘home’ system, such a system can be implemented in any environment such as a work space or outdoor space, such that the system comprises, and may be used to control, devices placed within the environment. A commonly used phrase for such a system and its devices is the Internet of Things (IoT) and IoT devices. In the Internet of Things (IoT) many kinds of devices are connected to the Internet, allowing elements of an environment such as heating and lighting to be controlled using dedicated devices which are networked together into the ‘home’ system.

The connected IoT devices are any devices capable of being connected to, or identified by, the system. These devices can communicate with each other and to a user device. The communication can be wireless according to a wireless networking protocol such as Zigbee, Wi-Fi or Bluetooth. During wireless communication between IoT devices, e.g. during commissioning when a new network device joins wireless network network credentials are exchanged, a rogue device (or a non-targeted device) can listen to the communication. Thus, rendering an insecure communication between IoT network devices.

EP2597806A1 discloses a method providing a receiver (Rx) and a transmitter (Tx), and providing a jammer command link that is utilized for linking the receiver and the transmitter. A set of instructions is provided to a set of platforms that is equipped with a set of jamming antennas. A set of measurements is taken continuously for the jamming antennas to optimize a set of iterations that is utilized for jamming of zones.

### SUMMARY OF THE INVENTION

It is therefore an object of the present invention to provide secure communication between wireless network devices within a wireless network.

According to a first aspect, the object is achieved by a controller for controlling wireless communication between a node and a master device in a wireless network; wherein the controller comprises a processor arranged for: determining a first directionally restricted jamming area relative to the node; determining a second directionally restricted jamming area relative to the master device; controlling a first directional antenna to transmit a first jamming signal in the determined first directionally restricted jamming area during a predetermined time period; and controlling a second directional antenna to transmit a second jamming signal in the determined second directionally restricted jamming area during the predetermined time period.

The wireless communication between a node and a master device may conveniently be of any suitable type, e.g. ZigBee, Bluetooth, LiFi, and/or WiFi, or even using for example infrared (IR). The master device may be a network administrator device, e.g. a building management system (BMS). In an example, the node may be a lighting device and the master device may be a lighting controller. The master device may send communication signals, including control commands to the node. A first and a second directionally restricted jamming area may be determined relative to (a physical location of) the node and the master device respectively and further based on the communication path between the node and the master device. For example, the first and the second directionally restricted jamming area may comprise an area not falling in the communication path between the node and the master device. The time period may comprise the time which is required to transfer a communication signal from a master device to a node or vice versa.

Since a first and a second directional antennas are arranged for transmitting a first and a second jamming signal in the determined first and the second directionally restricted jamming area, a secured communication path is provided between the node and the master device.

In an embodiment, the wireless communication may comprise a transmission of a wireless communication signal from the master device to the node; and wherein the wireless communication signal may comprise wireless network information to provide the node access to the wireless network using the wireless network information.

In an example, when a new node ‘joins’ a wireless network, wireless network information such as network identifiers, network credentials is shared with the new node. The master device may send such wireless network information to the node. In this example, a secure transfer of wireless network information is provided.

In an embodiment, the wireless communication signal may further comprise an encrypted wireless network key.

During commissioning, e.g. joining of a new node to a wireless network, one of the important communication signals comprises the encrypted wireless network key. The network key is used for the network communication. For example, for Zigbee wireless networks, the network key is encrypted using Zigbee master key. A rogue device may sniff/receive the wireless communication signal, and based on a knowledge of, e.g. Zigbee master key, the rogue device may decrypt the sniffed/received wireless communication signal. Hence, in this example, with the first and the second jamming signals, a secure commissioning of the node is provided.

In an embodiment, the controller may be arranged for restricting transmission of the first and the second jamming signals to a predetermined commissioning channel used by the wireless network.

The master device may determine a communication channel to perform commissioning. For example, for Zigbee wireless networks, the master device may choose from the sixteen communication channels allocated in 2.4 GHz band. For example, for Wifi the master device (e.g. Wifi access point) may choose one of the three working channels (e.g. 1, 6, or 11), and the commissioning including the key transport will be done at one of those channels. The jamming may be advantageously provided to the commissioning channel to avoid interruption of communication on other communication channels.

In an embodiment, the controller may be arranged for restricting transmission of the first and the second jamming signals to a specific spatial sector of non-target nodes on the predetermined commissioning channel for the predetermined time period.

The non-target nodes may comprise rogue nodes or malicious node. The rogue node may be a sniffer which may be aimed at sniffing the communication between the node and the master device. Alternatively, the non-target nodes may be other legitimate nodes in the wireless network. The first and the second directionally restricted jamming area may comprise spatial sector of non-target nodes. In an embodiment, the location of non-target nodes, such as rogue nodes, are not known and the spatial sector may be the spatial sector not comprising the communication path, e.g. the direction of communication from a master device to the node. In both cases, by restricting commissioning to spatial sector of non-target nodes, a secure commissioning is provided without disturbing the wireless network communication between the master device and the (legitimate) non-target nodes or in between the (legitimate) non-target nodes.

In an embodiment, the node and/or the master device may comprise the first and/or the second directional antennas, respectively.

In this example, the first and/or the second jamming antennas are respectively advantageously comprised in the node and/or the master device. In an alternatively embodiment, the first and/or the second directional antennas are external devices, external to node and the master device. The first and/or the second directional antennas may be comprised in other (legitimate) non-target nodes placed in proximity to the node and the master device.

In an embodiment, the first and/or the second directional antennas may comprise at least four directional antennas, respectively, and wherein at least three directional antennas of each of the at least four directional antennas may be controlled to transmit the first and the second jamming signals in the first and the second determined directionally restricted jamming areas respectively; and wherein at least one directional antenna of each of the at least four directional antennas may be controlled to perform the wireless communication between the node and the master device. In an embodiment, the first and/or the second directional antennas may comprise beam forming sector antennas.

In this embodiment, a secure communication path may be established using the at least four directional antennas, such that the at least three directional antennas of the at least four directional antennas may be performing jamming and the at least one directional antenna is performing the network communication. The at least one directional antenna for the first and the second directional antennas are directed towards or positioned in the communication path between the node and the master device. The at least three directional antennas are positioned in other different directions, different from the communication path. Further granularity of jamming and a sharper communication path may be setup using more directional antennas.

In an embodiment, the predetermined time period may comprise the time required for the node to access the wireless network. In an embodiment, the predetermined time period may be initiated by a coordinator device.

The time period may be the time to perform commissioning, such that node can join the wireless network. In an example, the commissioning time period may be initiated by an external coordinator device, e.g. a mobile phone, carried out by a coordinator or a commissioner. In an alternative example, the commissioning time period may be initiated by the master device. The time period may be initiated by the controller.

In an embodiment, the controller may be arranged for transmitting the first and/or the second jamming signal in response to a control command received from the master device.

In this advantageous embodiment, the master device may send a control command to control the first and/or the second directional antennas to transmit the first and/or the second jamming signal. For example, the control signal may be transmitted when the commissioning time period is initiated.

In an embodiment, the node may be a lighting device. In this example, the wireless network may be a connected lighting system, such that the node may be a lighting device, such as a light bulb. The master device may be a lighting controller arranged for controlling the lighting device. In such connected lighting device, a user may, e.g., control the illumination output of the lighting device via the master device.

According to a second aspect, the object is achieved by a jammer device comprising a controller according to the first aspect and a first and/or a second directional antenna for transmitting the first and/or the second jamming signal to the first and/or the second directionally restricted jamming area.

According to a third aspect, the object is achieved by a system for controlling wireless communication between a node and a master device in a wireless network; wherein the system comprises: a node and a master device; a jammer device according to the second aspect; and a controller according to the first aspect. In an embodiment, the system may be a lighting system; and wherein the node may be a lighting device and the master device may be a lighting controller.

According to a fourth aspect, the object is achieved by a method for controlling wireless communication between a node and a master device in a wireless network; wherein the method comprises: determining a first directionally restricted jamming area relative to the node; determining a second directionally restricted jamming area relative to the master device; controlling a first directional antenna to transmit a first jamming signal in the first determined directionally restricted jamming area during a predetermined time period; and controlling a second directional antenna to transmit a second jamming signal in the second determined directionally restricted jamming area during the predetermined time period.

According to a fifth aspect, the object is achieved by a computer program product comprising instructions which, when the program is executed by a computer, cause the computer to carry out the steps of the method of third aspect.

It should be understood that the computer program product and the method may have similar and/or identical embodiments and advantages as the above-mentioned systems/controller.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for controlling wireless communication between a node and a master device in a wireless network;

FIG. 2 shows schematically and exemplary another embodiment of a system for controlling wireless communication between a node and a master device in a wireless network;

FIG. 3 shows schematically and exemplary another embodiment of a system for controlling wireless communication between a node and a master device in a wireless network;

FIG. 4 shows a directional antenna pattern of a sector antenna;

FIG. 5 shows schematically and exemplary a flowchart illustrating an embodiment of a method for controlling wireless communication between a node and a master device in a wireless network.

All the figures are schematic, not necessarily to scale, and generally only show parts which are necessary in order to elucidate the invention, wherein other parts may be omitted or merely suggested.

### DETAILED DESCRIPTION OF EMBODIMENTS

The system 100 may comprise a master device 110 and a node 120. In an example, the system 100 may comprise a plurality of nodes and/or a plurality of master devices 110. The system 100 may exemplary be a lighting system, such as Philips Hue. The master device 110 may comprise a Philips Hue bridge and the node 120 may comprise a lighting device. A lighting device or luminaire is a device or structure arranged to emit light suitable for illuminating an environment, providing or substantially contributing to the illumination on a scale adequate for that purpose. A lighting device or luminaire comprises at least one light source or lamp, such as an LED-based lamp, gas-discharge lamp or filament bulb, etc., with any associated support, casing or other such housing. Each of the lighting devices or luminaires may take any of a variety of forms, e.g. a ceiling mounted luminaire, a wall-mounted luminaire, a wall washer, or a free-standing luminaire (and the luminaires need not necessarily all be of the same type).

The system 100 may be any wireless communication system such as an IoT system with sensors, actuators, switches, routers, gateways etc. The master device 110 may a building management system.

The wireless communication between the node 120 and the master device 110 may be performed according to any suitable wireless communication protocol. The node 120 and the master 110 may each be equipped with a wireless transmitter (not shown) or receiver (not shown) or transceiver (not shown) for sending and/or receiving wireless communication signal according to a wireless networking protocol such as Zigbee, Wi-Fi or Bluetooth.

The system 100 may further comprise a first directionally restricted jamming area 125 relative to the node 120 and a second directionally restricted jamming area 115 relative to the master device 110. In this example, the first and the second directionally restricted jamming areas 115-125 are (at least partially) overlapping. In an alternative example, the first and the second directionally restricted jamming areas 115-125 are non-overlapping. The system 100 may further comprise directionally unrestricted area, e.g. a communication path, 107, between the master device 110 and the node 120. A communication path may be defined as the physical path or area through which the master device 110 and the node 120 are able to exchange signals and messages. A communication link 103 may be the communications channel that connects two or more communicating devices. The first and the second directionally restricted jamming areas 115-125 may comprise all areas other than the communication path 107 through which the master device 110 and the node 120 can communicate. The first and the second directionally restricted jamming areas 115-125 may comprise spatial sector of non-target nodes 130a-d. The non-target nodes 130a-d may be rogue nodes, e.g. arranged for stealing wireless network credentials. Alternatively, the non-target nodes 130a-d may be legitimate nodes of the wireless network.

The wireless communication may comprise a transmission of a wireless communication signal from the master device 110 to the node 120; and wherein the wireless communication signal comprises wireless network information to provide the node 120 access to the wireless network using the wireless network information. In the commissioning phase, the master device 110 may provide the wireless network information comprising joining information to node 120, needed for network communication, so that the joining node 120 is added to the network, also referred to as “joining” the network or “association” of the joining node 120 with the network.

The wireless communication signal may further comprise an encrypted wireless network key. During the commissioning, the master device 110 transmits a wireless network key to the node 120. The wireless network key is then used by the node 120 to communicate with other legitimate nodes and/or with master device within the wireless network. Stealing of such a wireless network key may be a threat to network security. For example, a rogue node or a simple sniffer may listen to the wireless communication signal from the master device 110 to the node 120 and can steal the wireless network key. To increase security, the wireless network key is encrypted using a suitable encryption method, e.g. encryption based on AES algorithm (e.g. for Zigbee) or WPA2-PSK (AES) (e.g. for Wifi). For Zigbee wireless communication protocol, the wireless network key is encrypted using Zigbee master key. Using Zigbee master secret key is recommended by the Zigbee alliance standard. However, specific company or product can choose their own master secret key, which is also based on AES. Zigbee master secret key is a global key defined by ZigBee alliance. It is used as encryption key during the commissioning procedure (e.g. key transport mechanism). For a rogue device, with access to Zigbee master key (which is easily available e.g. on different online platforms) can decrypt the sniffed/received wireless communication signal and can steal the wireless network key.

To provide secure commissioning, a second directional antenna (not shown) may be controlled to transmit a second jamming signal in the second directionally restricted jamming area 115 during a predetermined time period. The time period may comprise the time the node 120 requires joining the wireless network, which in other words is the time required for commissioning the node 120 to the wireless network. The time period may be initiated by a coordinator device (not shown), such as a mobile phone, which may be carried out by a user (commissioner, not shown). The coordinator device may be an external device, external to the wireless network or at least external to the master device 110. The commissioning time may be initiated by the master device 110 and/or by the node 120. The first directionally restricted jamming area 115 is relative to the physical location of the master device 110. The rogue nodes 130a, b, d, due to the first jamming signal will not be able to listen to the wireless communication signal.

A second jamming signal is not sufficient to provide secure commissioning, because a rogue node 130c which is, e.g., physically placed behind the node 120 can still receive the wireless communication signal, and hence can steal the wireless network key. The second jamming signal can not jam communication behind the node 120 or at least outside the second directionally restricted jamming area 115. Therefore, a first directional antenna (not shown) may be controlled to transmit a first jamming signal in the first determined directionally restricted jamming area during the predetermined time period (commissioning time). When the commissioning is initiated, a friendly coordinated jamming is provided by both the first directional antenna and the second directional antenna during the commissioning time period. The coordination is important because the first and the second directional antennas are required to transmit the first and the second jamming signal during the commissioning time period. In an embodiment, the master device 110 may control such coordination.

A master device 110 may select a communication channel to perform commissioning (e.g. sending wireless network information), and wherein the transmission of the first and the second jamming signals may be restricted to a predetermined commissioning channel used by the wireless network. The transmission of the first and the second jamming signals may be restricted to a specific spatial sector of non-target nodes on the predetermined commissioning channel for the predetermined time period. In an example, the node 120 and/or the master device 110 may comprise the first and/or the second directional antennas, respectively.

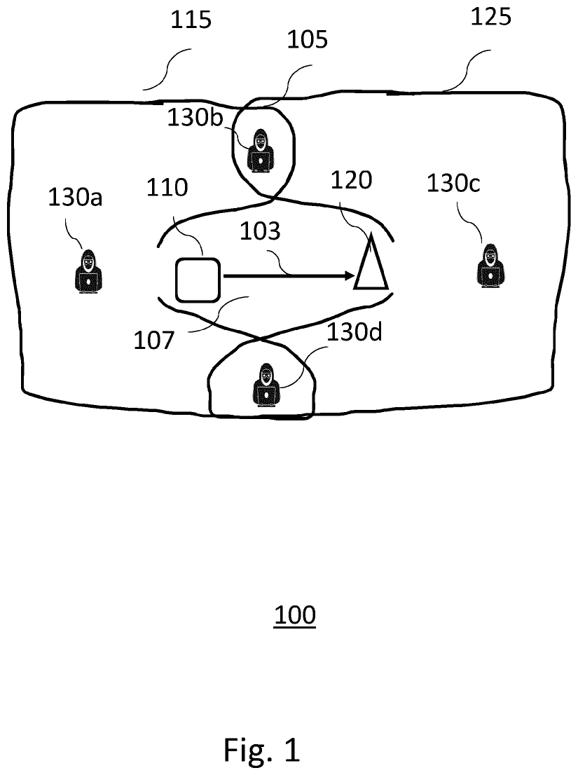

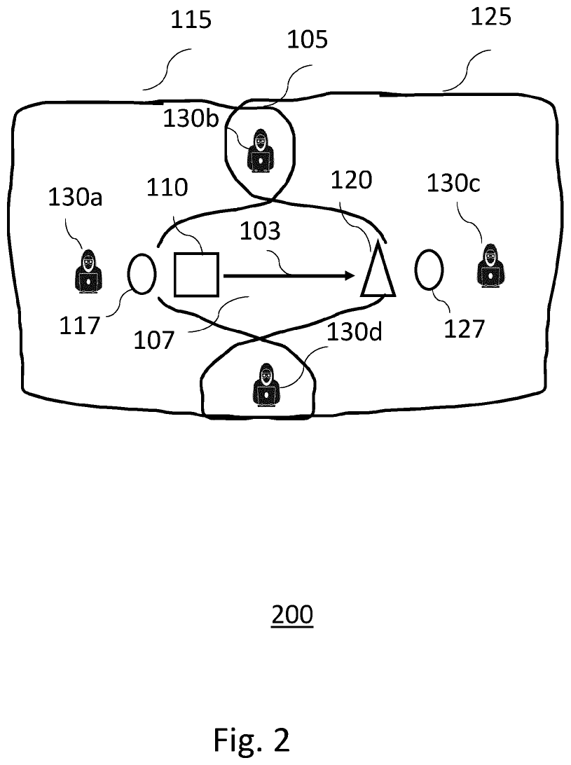

FIG. 2 shows schematically and exemplary another embodiment of a system 200 for controlling wireless communication between a node 120 and a master device 110 in a wireless network. The system 200 is similar to system 100 (e.g. the numerals are kept as in FIG. 1) except that the first and the second directional antennas are external to the node 110 and the master device 120. The external first and the second directional antennas are comprised in jammer devices 117-127 respectively. The jammer devices 117-127 provide a friendly coordinated jamming for the first and the second directionally restricted jamming areas 115-125. In an example, the first directional antenna may be comprised in the master device 110 and the second directional antenna may be comprised in the external jammer device 127. In an alternative example, the second directional antenna may be comprised in the node 120 and the first directional antenna may be comprised in external jammer device 117.

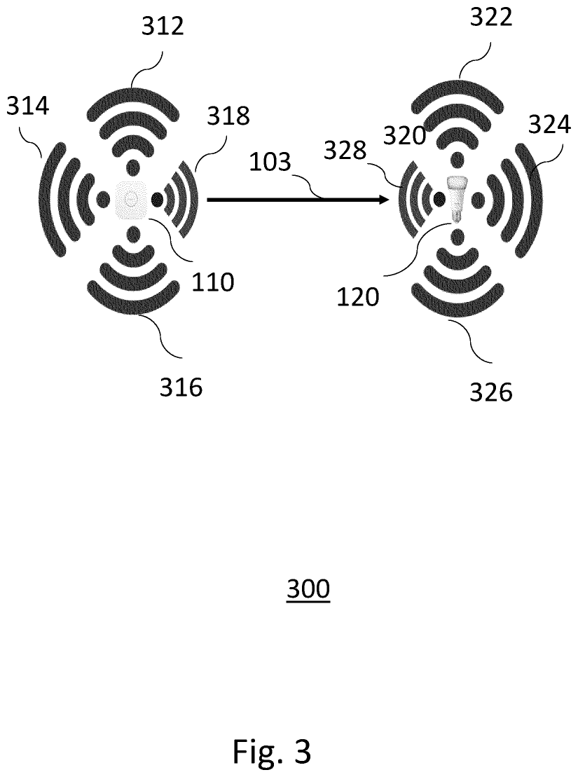

FIG. 3 shows schematically and exemplary another embodiment of a system 300 for controlling wireless communication between a node 120 and a master device 110 in a wireless network. In this embodiment, the first directional antennas may comprise at least four directional antennas 312, 314, 316, 318, and the second directional antennas may comprise at least four directional antennas 322, 324, 326, 328. In such an example, at least three directional antennas 312, 314, 316/322, 324,326 of each of the at least four directional antennas are controlled to transmit the first and the second jamming signals in the first and the second directionally restricted jamming areas 115, 125. The at least one directional antenna 318, 328 of each of the at least four directional antennas are controlled to perform the wireless communication between the node 120 and the master device 110. To improve security, a higher number of directional antennas may be used as well.

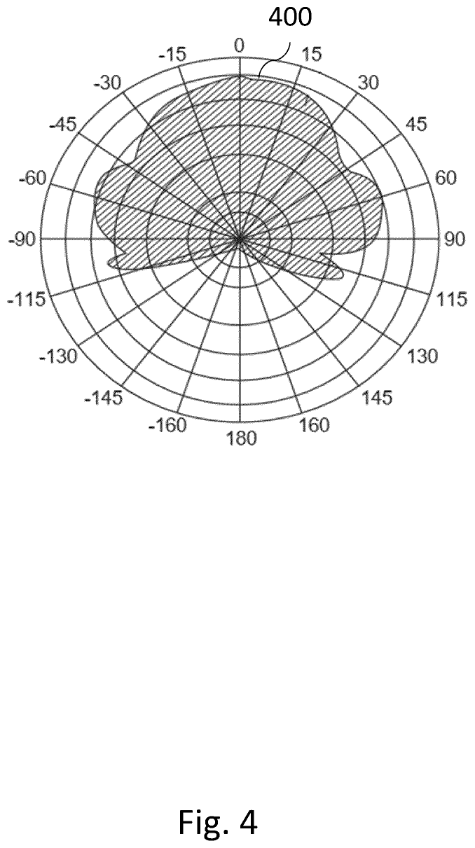

FIG. 4 shows an exemplary directional antenna pattern 400 of a sector antenna that can be used by the proposed jammer device as a beamforming antenna to transmit the first and the second jamming signal for non-target nodes located in a specific spatial sector.

By using beamforming technique, the jamming area can be sectorized and restricted for spatial jamming. That is, jamming can be selectively applied to specific sector(s). As shown in FIG. 4, according to the exemplary antenna pattern 400, the power gain can be directed to a specific sector roughly between −90° and +90°.

Beamforming or spatial filtering is a signal processing technique used in sensor or antenna arrays for directional signal transmission or reception. This can be achieved by combining elements in an antenna array in such a way that signals experience constructive interference while others experience destructive interference at particular angles. To change the directionality of the array during transmission, a beamformer may control the phase and relative amplitude of the wireless communication signal at each transmitter, in order to create a pattern of constructive and destructive interference in the wave front. At the receiver side, information from different sensors or antenna elements is combined in a way that the expected pattern of radiation is preferentially observed. The improvement compared with omnidirectional reception/transmission is known as directivity of the array.

Beamforming techniques can be broadly divided into conventional (fixed or switched beam) beamformers and adaptive beamformers or phased array with desired signal maximization mode or interference signal minimization or cancellation mode. Both techniques may be used to implement the proposed friendly coordinated jamming.

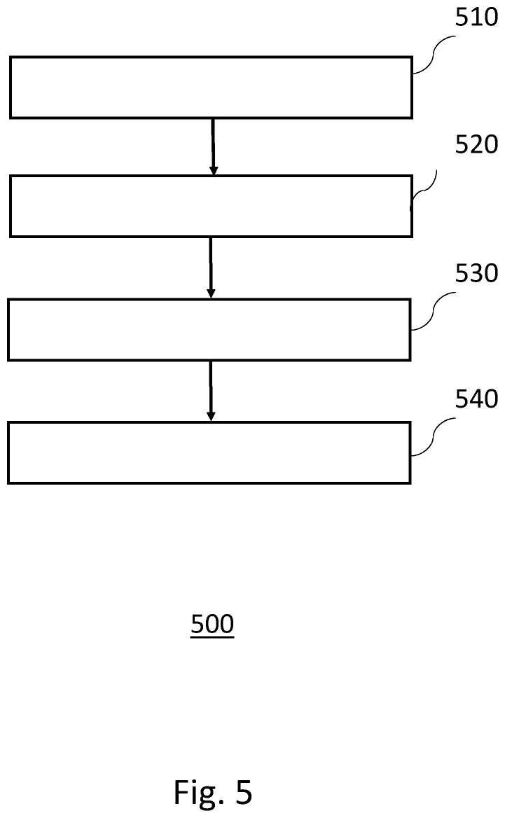

FIG. 5 shows schematically and exemplary a flowchart illustrating an embodiment of a method 500 for controlling wireless communication between a node 120 and a master device 110 in a wireless network. The method 500 may comprise determining 510 a first directionally restricted jamming area 125 relative to the node 120. The method 500 may further comprise determining 520 a second directionally restricted jamming area relative 115 to the master device 110. The determination 510-520 may be based on the communication path 107 between the node 120 and the master device 110 and/or based on the physical location of the non-target nodes. It should be understood that the order of the method steps is exemplary shown and a suitable different ordering is also possible.

The method 500 may further comprise controlling 530 a first directional antenna to transmit a first jamming signal in the first determined directionally restricted jamming area 125 during a predetermined time period. The method 500 may comprise controlling 540 a second directional antenna to transmit a second jamming signal in the second determined directionally restricted jamming area 115 during the predetermined time period. A controller (not shown) may be arranged for executing the method steps 510-540. The controller may be implemented in a unit separate from the node 120 and the master device 110, such as wall panel, desktop computer terminal, or even a portable terminal such as a laptop, tablet or smartphone. The controller may be implemented in the coordinator device. Alternatively, the controller may be incorporated into the same unit as the node 120 and/or the same unit as the master device 110. In an example, the functionality of the controller is replaced by the master device 110. Further, the controller may be implemented in the environment or remote from the environment (e.g. on a server of the building or even outside the building at a different geographical site); and the controller may be implemented in a single unit or in the form of distributed functionality distributed amongst multiple separate units (e.g. a distributed server comprising multiple server units at one or more geographical sites, or a distributed control function distributed amongst the node 120 or amongst the node 120 and master device 110). Furthermore, the controller may be implemented in the form of software stored on a memory (comprising one or more memory devices) and arranged for execution on a processor (comprising one or more processing units), or the controller may be implemented in the form of dedicated hardware circuitry, or configurable or reconfigurable circuitry such as a PGA or FPGA, or any combination of these.

The jamming effect of the first and the second jamming signal may depend on its transmission power, location and influence on the network or the jammed devices. The jammer device may jam the network in various ways to make jamming as effective as possible.

Jamming in wireless networks can be defined as a disruption of existing wireless communications by decreasing the signal-to-noise ratio at receiver sides through the transmission of interfering wireless signals.

As an example, the actual friendly jamming may be accomplished by transmitting something that looks like noise (e.g. pseudorandom bits) at a sufficient power level. If the transmission power is high enough in relation to the first and the second directionally restricted jamming area 115-125, the first and the second jamming signal will distort other traffic within the first and the second directionally restricted jamming area 115-125 to a point where it's indistinguishable from noise. Since no more traffic is getting through, the wireless communication signal can not be received by the non-target (rogue) nodes.

Furthermore, jamming can be done at different levels, from hindering transmission (e.g. radio jamming) to distorting packets in legitimate communications (e.g. link-layer jamming). By exploiting semantics of the link-layer protocol (i.e. MAC protocol), better jamming efficiency can be achieved compared to blindly jamming the radio signals alone. The friendly coordinated jamming may be performed only for a few seconds (e.g. 100 ms or 1 sec). Thus, the wireless network communication can be performed, e.g., transfer of the wireless communication signal, between the node 120 and the master device 110, and the rest of communication will not be significantly disturbed.

There are several types of jammers that can be used. According to generic jammer models, the jammer device, e.g. the first and the second directional antennas, may be a constant jammer that emits continuous, random bits without following a channel sense multiple access (CSMA) protocol of the MAC layer, a deceptive jammer that continuously transmits regular packets instead of random bits, a random jammer that intermittently transmits either random bits or regular packets into networks, a reactive jammer (such as a request-to-send (RTS)/clear-to-send (CTS) jammer that reacts on a sensed RTS message, or a Data/Acknowledgement jammer that jams the network by corrupting transmissions of data or acknowledgement (ACK) packets), a function-specific jammer (such as a follow-on jammer that hops over all available channels very frequently and jams each channel for a short period of time, or a channel-hopping jammer that hops between different channels proactively with direct channel access by overriding a CSMA algorithm provided by the MAC layer, or a pulsed-noise jammer that can switch channels and jam on different bandwidths at different periods of time), or a smart-hybrid jammer (such as a control-channel jammer that targets a control channel or other channel used to coordinate network activity, or an implicit jammer that in addition to disabling the functionality of the intended target, causes denial-of-service state at other nodes of the network too, or a flow jammer that jams packets to reduce traffic flow by using information from the network layer).

Moreover, the jammer device can be selective if it can be programmed to attack just specific frames. As the commissioning messages (wireless communication signals) are sent on different channels redundantly, it can be further distinguished between narrowband and wideband jamming depending on whether only a single or multiple commissioning channels are to be jammed at the same time.

The different jammer types vary with regard to their efficiency, power-consumption and complexity. A constant wideband jammer emits noise over a large frequency range. Although it has a low complexity, its efficiency is low and energy consumption is high. This is because such a jammer may have to jam all three advertisement channels simultaneously which are spread over the whole 2.4 GHz band.

A constant narrow-band jammer emits the jamming signal permanently but only on a single channel. As in this case only a single channel can be jammed at a same time, frequency hopping may need to be applied.

A reactive wideband jammer is based on the observation that wireless communication signals are only sent at certain points in time, e.g. every second. Therefore, it may be sufficient to emit the jamming signal only during frame transmission. Hence, such a periodic jammer needs to synchronize with the master device source to be filtered out, which requires a sniffing or channel sensing component.

A reactive narrow-band jammer emits the jamming signal on a single channel only when a frame transmission to be attacked has been detected. Again, frequency hopping may need to be performed in order to not miss beacon frames transmitted on other channels.

The jammer device may be reactive as only a short jamming signal is intended to be emitted during transmission of an advertisement frame which is long enough to corrupt the frame (e.g. due to an error checking failure).

The jammer device may be a commercial off-the-shelf (COTS) embedded hardware. One option would be to use a Software-Defined Radio (SDR) like the Universal Software Radio Peripheral (USRP), but there may be a more economical solution available, such as a small Uniform Serial Bus (USB) device called Ubertooth with less expensive and power-hungry software-defined radio hardware (e.g. USRP).

The jammer device may be software-controlled and the jamming program may be an interrupt-controlled state machine. After a jamming signal transmission is stopped, a transmitter or transceiver of the jammer device may be tuned to the next advertising channel to receive and to repeat the process. To avoid being stuck at one channel a timeout (e.g. 10 ms) may be started (which is the maximum time between two advertising frames on consecutive used advertising channels sent in one advertising event). On a timeout the jammer device may return to the first advertising channel. If no timeout occurs, the jamming process may continue as on the previous channel and repeats on the last channel afterwards.

The method 500 may be executed by computer program code of a computer program product when the computer program product is run on a processing unit of a computing device.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A controller for controlling wireless communication between a node and a master device in a wireless network; wherein the controller comprises a processor configured for:
determining a first directionally restricted jamming area relative to the node;
determining a second directionally restricted jamming area relative to the master device; wherein the first and the second directionally restricted jamming area comprise an area not falling in the communication path between the node and the master device;
controlling a first directional antenna to transmit a first jamming signal in the determined first directionally restricted jamming area during a predetermined time period; wherein the predetermined time period comprises the time required for commissioning the node to the wireless network; and
controlling a second directional antenna to transmit a second jamming signal in the determined second directionally restricted jamming area to provide a friendly coordinated jamming during the commissioning time period; and wherein the controller is arranged for restricting transmission of the first and the second jamming signals to a predetermined commissioning channel used by the wireless network.

2. The controller according to claim 1, wherein the wireless communication comprises a transmission of a wireless communication signal from the master device to the node; and wherein the wireless communication signal comprises wireless network information to provide the node access to the wireless network using the wireless network information.

3. The controller according to claim 2, wherein the wireless communication signal further comprises an encrypted wireless network key.

4. The controller according to claim 1, wherein the controller is configured for restricting transmission of the first and the second jamming signals to a specific spatial sector of non-target nodes on the predetermined commissioning channel for the predetermined time period.

5. The controller according to claim 1, wherein the node and/or the master device comprise the first and/or the second directional antennas, respectively.

6. The controller according to claim 1, wherein the first and/or the second directional antennas comprises at least four directional antennas, respectively, and wherein at least three directional antennas of each of the at least four directional antennas are controlled to transmit the first and the second jamming signals in the first and the second determined directionally restricted jamming areas respectively; and wherein at least one directional antenna of each of the at least four directional antennas are controlled to perform the wireless communication between the node and the master device.

7. The controller according to claim 1, wherein the first and/or the second directional antennas comprise beam forming sector antennas.

8. The controller according to claim 1, wherein the predetermined time period is initiated by a coordinator device.

9. The controller according to claim 1, wherein the controller is arranged for transmitting the first and/or the second jamming signal in response to a control command received from the master device.

10. A jammer device comprising the controller according to claim 1 and a first and/or a second directional antenna for transmitting the first and/or the second jamming signal to the first and/or the second directionally restricted jamming area.

11. A system for controlling wireless communication between a node and a master device in a wireless network; wherein the system comprises:
a node and a master device;
a jammer device; and
a controller according to claim 1.

12. The system according to claim 11, wherein the system is a lighting system;
and wherein the node is a lighting device and the master device is a lighting controller.

13. A method for controlling wireless communication between a node and a master device in a wireless network; wherein the method comprises:
determining a first directionally restricted jamming area relative to the node;
determining a second directionally restricted jamming area relative to the master device; wherein the first and the second directionally restricted jamming area comprise an area not falling in the communication path between the node and the master device;
controlling a first directional antenna to transmit a first jamming signal in the first determined directionally restricted jamming area during a predetermined time period; wherein the predetermined time period comprises the time required for commissioning the node to the wireless network; and
controlling a second directional antenna to transmit a second jamming signal in the second determined directionally restricted jamming area to provide a friendly coordinated jamming during the commissioning time period; and wherein the controller is arranged for restricting transmission of the first and the second jamming signals to a predetermined commissioning channel used by the wireless network.

14. A non-transitory computer program product comprising instructions which, when the program is executed by a computer, causes the computer to perform the method of claim 13.
